(19) United States
(12) Patent Application Publication
(10) Pub. No.: US 2001/0045033 A1
(43) Pub. Date: Nov. 29, 2001

(54) Personal interest semaphore system

(76) Inventor: Jeffrey Fischer, Boca Raton, FL (US)

Correspondence Address: JOHN C. SMITH, ESQ., 4800 NORTH FEDERAL HIGHWAY, SUITE A-207, BOCA RATON, FL, 33431, US

(21) Appl. No.: 09/827,698

(22) Filed: Apr. 6, 2001

Related U.S. Application Data
(60) Provisional application No. 60/195,615, filed on Apr. 7, 2000.

(51) Int. Cl. G09C 3/00; B42D 15/00

(52) U.S. Cl. 40/541

(57) ABSTRACT

A color-coded semaphore system in which an individual wears a semaphore that signals characteristics and interests for social purposes. Each color indicates a specific quality related to the individual, such as, but not limited to, personality type, marital status, religion, politics, the type of person that the individual is interested in meeting, etc. The semaphores indicate the qualities of the individual wearing the semaphore, but also indicate to others what qualities the individual may be seeking, such as, but not limited to, personality type, marital status, religion, politics, etc. The semaphore system can be implemented using a variety of color-coded items, such as jewelry (e.g. rings, necklace's, pendants, pins, tie tacks, bracelets, body piercing jewelry, etc.), or garments using color-coded insignia. Other alternative embodiments allow multiple semaphores to be worn simultaneously to allow a variety of the individual's interests to be signaled. An optional indicia can be used in conjunction with the semaphores to inform other individuals that semaphores are being used.

### CROSS-REFERENCE TO RELATED APPLICATIONS

This application is related to the commonly owned copending provisional patent application entitled “Personal Interest Semaphore System,” filed Apr. 7, 2000, bearing U.S. Ser. No. 60/195,615 and naming Jeffrey Fischer, the named inventor herein, as sole inventor, the contents of which is specifically incorporated by reference herein in its entirety.

### BACKGROUND OF THE INVENTION

1. Technical Field

The present invention relates to personal communications devices. In particular, it relates to a semaphore system which an individual can use in combination with jewelry or garments to signal the individual's characteristics and interest to others.

2. Background Art

Many individuals, both male and female, would enjoy meeting other individuals for social purposes. Most of these individuals would also prefer to meet others with like interests or with specific qualities. Unfortunately, in today's world, an individual cannot immediately tell much about another individual when they initially meet. As a result, this creates a situation where an individual may spend a considerable amount of time with someone before they find out whether or not they are compatible.

It would be desirable to be able to indicate to others some important qualities about the individual and what type of companion is being sought. However, there has heretofore been no convenient and discrete way of signaling to another person what an individual's interests and characteristics are. As a result, individuals may spend substantial amounts of time in social interaction with others before they realize that the other individual is incompatible with them.

The prior art has failed to provide a method for an individual to discretely and quickly indicate to others the qualities and interests of the individual which would be important in establishing a relationship.

### SUMMARY OF THE INVENTION

The present invention solves the foregoing problems by providing color-coded semaphore devices which the user wears for social purposes. Each color indicates a specific quality related to the individual, such as personality type, marital status, religion, politics, the type of person that the individual is interested in meeting, etc. Alternative embodiments of the semaphore system can be implemented using a variety of color-coded items, such as jewelry (e.g. rings, necklace's, pendants, pins, tie tacks, bracelets, body piercing jewelry, etc.), or garments using color-coded insignia. Other alternative embodiments allow multiple semaphore's to be worn simultaneously to allow a variety of the individual's interests and characteristics to be signaled.

### BRIEF DESCRIPTION OF THE DRAWINGS

FIG. 1 illustrates a preferred embodiment of the semaphore system which uses rings for the signaling device.

FIG. 2 is chart indicating a preferred embodiment of the color coding scheme used by the semaphore system.

FIG. 3A illustrates a preferred embodiment of the semaphore system which allows multiple colors to be simultaneously used to indicate to a plurality of interests.

FIG. 3B illustrates a preferred embodiment of the semaphore system which allows multiple semaphore devices to be simultaneously worn to indicate to a plurality of interests.

### DESCRIPTION OF THE PREFERRED EMBODIMENT

Prior to a detailed discussion of the figures, a general overview of the system will be presented. In today's social environment, individuals have substantial difficulty in finding other compatible individuals. Due to this, many individuals either waste a considerable amount of time seeking other like minded individuals or individuals with specific qualities and interests, or cannot find them at all. The purpose of the semaphore system disclosed herein is to allow an individual, when visiting any social venue, a restaurant or nightclub, etc. to quickly and easily let others know the characteristics and interests of that individual. Likewise, if others are also using the semaphore system, the individual can easily tell if that person is of interest to the individual. As a result, the individual benefits because the individual can easily and quickly locate other compatible parties, or parties with desirable traits or interests. In addition, in the case where the individual and the other party are not compatible or do not have desirable traits or characteristics, both the individual and the other party benefit because they do not waste substantial amounts of their time determining that they are not compatible. This allows them to use that time to find a compatible individual or an individual with desirable traits or characteristics.

In a preferred embodiment of the semaphore system, a semaphore color coding system is combined with jewelry. The jewelry may be worn directly on the body or it may be attached to clothing. By combining the semaphore system with jewelry, an individual can make use of the semaphore system without carrying anything in addition to conventional fashion accessories. This makes it more convenient for the individual to make use of the semaphore system. Likewise, it allows the individual to signal their interests and characteristics in a subtle and unobtrusive manner.

Of course, no one can be defined by a single characteristic or interest. As a result, alternative embodiments provide for the use of multiple colors to indicate a variety of characteristics or interests which an individual is seeking in a like minded, compatible, or desirable party. In one embodiment, a ring with a color-coded band is used. If more than one color-coded item is desired, then assuming that the rings are suitably sized, multiple rings may be worn. Alternatively, a single ring may be fashioned with multiple color bands, stripes, spots, etc. to indicate the characteristics and interests that are of highest importance to the individual.

In addition to jewelry, the semaphore system can also be used in combination with clothing. For example, a particular color may indicate the same preferences which are indicated on the jewelry. The color system can be used in combination with any type of clothing or accessory.

Those skilled in the art will recognize that individuals already wear garments and jewelry which use any number of colors. Therefore, an optional method of indicating that the semaphore system is being used can be accomplished in several ways. For example, in the case of jewelry a specific design may be used to indicate that the jewelry is part of a semaphore system. In this manner, a design in combination with a color would give clear notice to another individual that the jewelry was actually used as a semaphore. In addition, while an ornamental design may be useful in providing tacit notice of the semaphore system to another individual, explicit notice may also be given. This can be accomplished through the use of a unique symbol, or name, which is displayed on the jewelry or clothing. This symbol can be any form of unique design, and the name might be any convenient mark, such as “Kalume” (TM). This symbol, whether a design or name, would preferably be a trademark associated with the semaphore system.

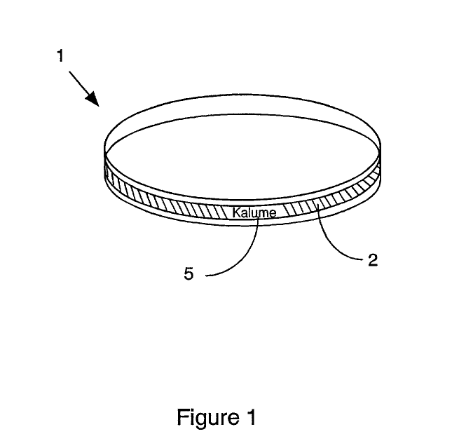

FIG. 1 is a diagram that illustrates the use of rings as the semaphore device. In this figure, a ring 1 is shown which has a color semaphore 2. For illustrative purposes, the semaphore 2 is arranged as a center stripe in the middle section of ring 1 as shown. However, the semaphore 2 can just as easily be implemented in any number of other convenient and decorative configurations. For example, the semaphore 2 can be the entire ring 1. Likewise, the semaphore 2 can be implemented as dots or smaller segments of the ring 1. In addition, the semaphore 2 can be implemented not only as a solid decorative part of the ring 1, but it can also be implemented as a colored gem stone or like item.

This figure also illustrates the use of an optional and arbitrary indicia 5 (i.e. “Kalume”), which indicates that the colors on the ring 1 are part of the semaphore system. Of course, any logo can be used as the indicia 5, whether or not it contains text. There is an additional advantage of using the indicia 5 in the form of a trademark, because this is an accepted and common use on many types of garments and jewelry items.

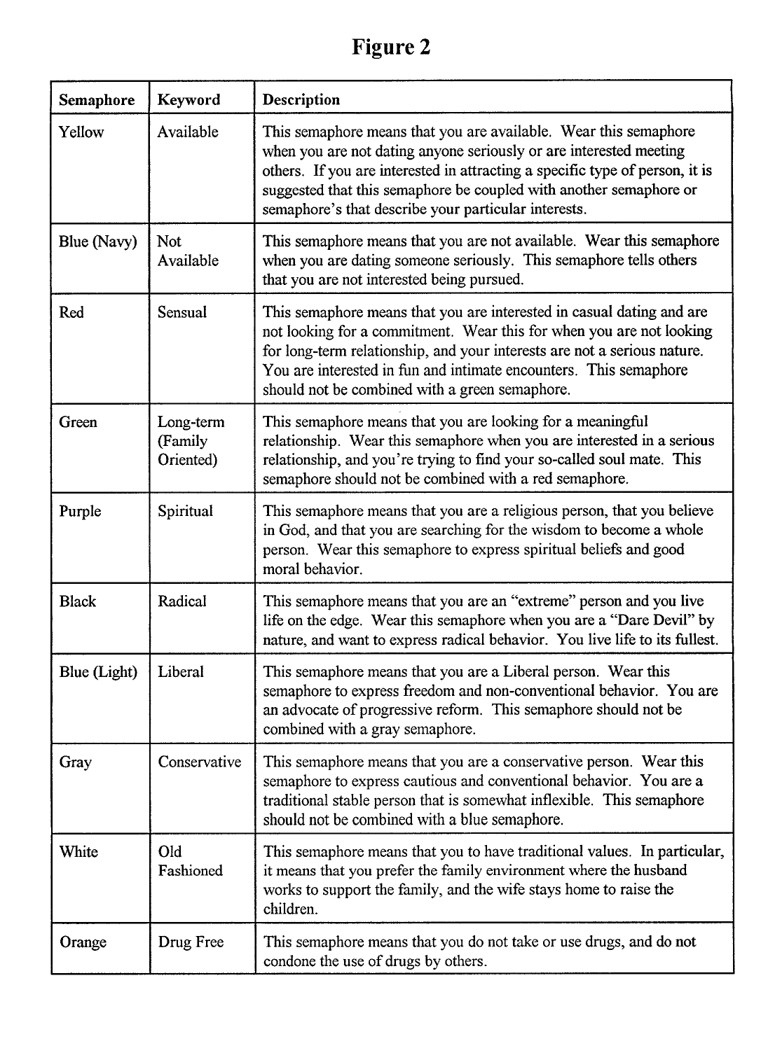

In FIG. 2 is a chart indicating the preferred colors used by the color-coded semaphore system. As shown in the figure, each color is a semaphore which describes a trait or interest of the individual. In general, these traits can be succinctly described by a short keyword or keywords. The keywords are listed to the right of the semaphores. In addition, to the right of the keywords in this figure are more complete descriptions of the semaphores, and where appropriate, their ability to interact. For example, a red semaphore which indicates a sensual person looking for a short-term casual relationship would not be combined with a green semaphore which indicates someone looking for a long term serious relationship.

While these particular colors are used as the semaphore in the preferred embodiment, those skilled in the arts will recognize that any agreed upon set of colors can be used to implement this system. Likewise, the particular traits used by the semaphore system can vary to suit a particular person's interests or cultural environment.

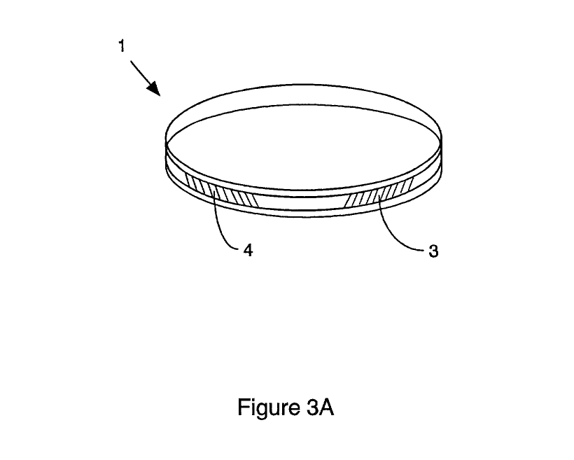

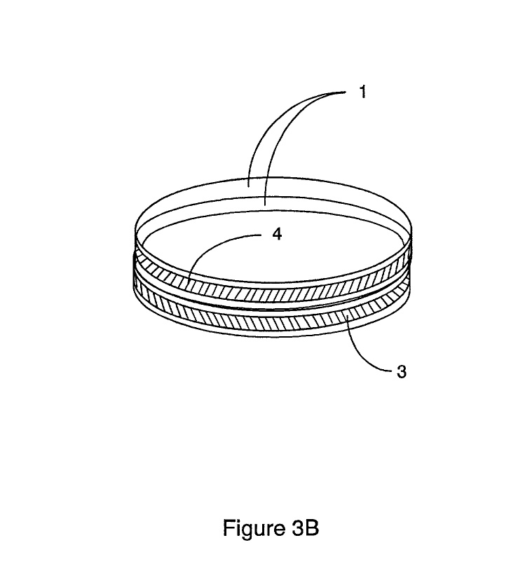

FIG. 3A illustrates a preferred embodiment of the semaphore system which allows multiple colors to be simultaneously used to indicate a plurality of interests. This figure uses the color scheme shown in FIG. 2, as discussed above. In this embodiment, the semaphore system uses a ring 1 to carry multiple semaphores 3 and 4. These semaphores 3, 4 can indicate any compatible set of qualities or traits. For example, semaphore 3 may be red to indicate a sensual person and semaphore 4 may be orange to indicate a sense of humor. However incompatible semaphores, such as red and green, which respectively indicate someone seeking a casual relationship, and someone seeking a long-term person relationship, should not be used together.

FIG. 3B illustrates an alternative preferred embodiment of the semaphore system which allows multiple semaphore carrying rings 1 to be simultaneously worn to indicate a plurality of interests. Those skilled in the art will recognize that in addition to multiple rings 1, a single ring with multiple semaphores 3, 4 can be used. Of course, the same technique can be used with other forms of jewelry. In addition, multiple colors can be displayed on clothing items in like fashion.

While the invention has been described with respect to a preferred embodiment thereof, it will be understood by those skilled in the art that various changes in detail may be made therein without departing from the spirit, scope, and teaching of the invention. For example, the colors used may vary, the meaning of the colors may vary. The material used to fabricate the jewelry or clothing may vary, etc. Accordingly, the invention herein disclosed is to be limited only as specified in the following claims.

I claim:

1. A personal interest semaphore system, further comprising:
at least one ornamental semaphore which can be worn on the first individual, or attached to the first individual's clothing, or incorporated into the first individual's clothing, which indicates a characteristic or trait of the first individual or a characteristic or trait which the first individual desires in a second individual;
whereby the first individual can signal the first individual's interests in desires to a second individual via the semaphores, and the second individual can interpret the semaphores to understand the characteristics and traits of the first individual and the characteristics and traits desired by the first individual.
